(19) United States
(12) Patent Application Publication
(10) Pub. No.: US 2020/0037654 A1
(43) Pub. Date: Feb. 6, 2020

(54) PEANUT PROTEIN VEGETARIAN SAUSAGE AND PREPARATION METHOD THEREOF

(71) Applicants: Institute of Food Science and Technology, Chinese Academy of Agricultural Sciences, Haidian District, Beijing (CN); Wilmar (Shanghai) Biotechnology Research & Development Center Co., Ltd., Pudong New Area Shanghai (CN)

(72) Inventors: Qiang WANG, Haidian District, Beijing (CN); Li LIU, Haidian District, Beijing (CN); Jinchuang ZHANG, Haidian District, Beijing (CN); Song ZHU, Haidian District, Beijing (CN); Aimin SHI, Haidian District, Beijing (CN); Hui HU, Haidian District, Beijing (CN); Hongzhi LIU, Haidian District, Beijing (CN); Yuanrong JIANG, Pudong New Area Shanghai (CN); Yuquan ZHANG, Pudong New Area Shanghai (CN)

(21) Appl. No.: 16/491,824

(22) PCT Filed: May 3, 2018
(86) PCT No.: PCT/CN2018/085465

§ 371 Date: Sep. 6, 2019

(30) Foreign Application Priority Data
Feb. 12, 2018 (CN) 201810146196.3

(51) Int. Cl. A23L 33/185; A23L 19/10; A23L 29/00; A23P 30/10; A23P 30/25

(52) U.S. Cl. CPC A23L 33/185; A23L 19/115; A23P 30/25; A23P 30/10; A23L 29/015

(57) ABSTRACT

A peanut protein vegetarian sausage and a preparation method thereof are described. The peanut protein vegetarian sausage is prepared from components including low-temperature defatted peanut protein powder, soybean protein isolate, vital wheat gluten, and modifier. The vegetarian sausage has a protein content of 60% or more, zero cholesterol and low fat, and has the characteristics of good taste, being rich in nutrients and convenience to eat. Also described are a preparation method of the vegetarian sausage, which includes mixing the main materials, performing an extrusion treatment, adding water and an auxiliary material online during the extrusion, and cooling the product obtained after extrusion molding to give the peanut protein vegetarian sausage. The preparation method is a pure physical processing method with a high degree of automation, and the processing is free from any pollutant discharge.

### TECHNICAL FIELD

The present invention relates to the field of food processing, in particular to a peanut protein vegetarian sausage and a preparation method thereof.

### BACKGROUND ART

Vegetable protein is an important source of proteins in human diet, and 80% of the world's protein yield is vegetable protein, which is mainly from grains, oil crops and beans. Vegetable protein has high nutritional value, basically balanced amino acid composition, high content of essential amino acids, and high energy conversion efficiency, and vegetable protein is almost free of cholesterol and saturated fatty acid, is easy to digest and absorb, and is a nutrient-rich food resource, and meanwhile, vegetable protein also has a variety of physiological functions, such as lowering cholesterol, anti-tumor and improving cardiovascular function. The “Dietary Guidelines for US Residents” latest revised in 2015 points out that protein intake should be diversified and vegetarianism should be promoted. In 2014 and 2016, the Chinese government further issued two programmatic documents, “China Food and Nutrition Development Program (2014-2020)” and “Dietary Guidelines for Chinese Residents (2016)”, proposed the concept of “healthy China”, which raises guarantee of the health of Chinese residents to a national strategy, and advocated the supplementation of vegetable proteins. China is the world's first producer and consumer of peanuts. In 2016, China's peanut yield was 17 million tons, accounting for 40% of the world's total yield. 50% to 65% of the total peanut yield is used for making oil. The defatted peanut cake is a by-product of the peanut kernel after oil extraction by squeezing or leaching, and has a protein content of up to 50% to 70% (dry basis). It is estimated that about 3 million tons or more of peanut cakes are urgently needed for development and utilization in China, which can be converted into peanut protein of about 1.5 million tons or more, which has become the third largest source of vegetable protein after wheat and soybean in China. The peanut protein powder is bright and white, contains no cholesterol or flatulence factor, and has a digestive coefficient of up to 90%. The characteristic amino acid arginine has the effect of delaying aging and has extremely high development and utilization value.

For a long time, the chronic diseases caused by eating animal meat have seriously interfered with people's healthy life. The production of animal meat also consumes large amounts of food and drinking water and produces greenhouse gases, being unsustainable. Meat products produced by traditional processes such as ham sausages and cured meats require complicated procedures and require the addition of sodium nitrite, which may cause potential harm to humans. The vegetable protein extrusion-texturization technology is a high-tech green food processing technology that uses vegetable proteins such as soybean protein, peanut protein, gluten protein and whey protein as main raw materials, which are subjected to maturation and molding by an extruder to produce food having the fiber structure and mouthfeel of animal meat. In recent years, high-moisture extrusion-texturization technology has attracted much attention. The moisture content during the extrusion is generally above 50%, and the obtained product is high-moisture texturized protein, which has longer fibers, more delicate structure, and more uniform texture, similar to the animal meat, and has the characteristic of ready-to-eat. With the constant pursuit to nutrition, health and deliciousness, vegetable protein mock meat products will become the choice of more persons.

### SUMMARY OF THE INVENTION

A first purpose of the present invention is to provide a peanut protein vegetarian sausage, which can be used as fast foods, snack foods, and cooking base foods.

The vegetarian sausage is prepared from components including, in parts by weight, the following raw materials:

| | | |
|---|---|---|
| low-temperature defatted peanut protein powder | 50 to 100 | parts |
| soybean protein isolate | 5 to 50 | parts, |
| vital wheat gluten | 5 to 50 | parts. |

According to the present invention, the low-temperature defatted peanut protein powder has a protein content of 55% or more, and a fat content of 7% or less;

The soybean protein isolate has a protein content of 80% or more, and a fat content of 1.8% or less;

The vital wheat gluten has a protein content of 60% or more, and a fat content of 0.9% or less.

On the basis of the preferred protein powder type, the further preferred formulation of the present invention comprises 50 to 90 parts by weight of low-temperature defatted peanut protein powder, 5 to 40 parts by weight of soybean protein isolate and 5 to 40 parts by weight of vital wheat gluten.

In the present invention, soybean protein isolate and vital wheat gluten are further added on the basis of the low-temperature defatted peanut protein powder. By the rational combination of the three materials, the vegetarian sausage prepared in the present invention is richer in nutrients, and has better shape and taste. In order to endow the vegetarian sausage with better shape and taste, a modifier is further added.

According to the present invention, the vegetarian sausage further comprises 0.01 to 3 parts of modifier.

The modifier is one or more selected from protease, konjac flour, and sodium carbonate; preferably, the protease is glutamine transaminase.

In the case of the protease being selected as the modifier, when the amount of the protease is 0.05% to 2%, preferably 0.4% to 1.1%, of the total amount of the low-temperature defatted peanut protein powder, soybean protein isolate and vital wheat gluten, the improvement effect is better;

According to the present invention, the vegetarian sausage further comprises an auxiliary material, and the auxiliary material is one or more of essence, pigment, salt, and water-retaining agent;

Preferably, the auxiliary material includes 0.5 to 5 parts of essence, 0.005 to 0.1 parts of pigment, 0.2 to 5 parts of salt, and 0.01 to 5 parts of water-retaining agent;

More preferably, the auxiliary material includes 0.5 to 1.5 parts of essence, 0.01 to 0.1 parts of pigment, 0.2 to 0.8 parts of salt, and 0.1 to 1 parts of water-retaining agent;

Preferably, the essence is one selected from chicken essence, beef essence, pork essence or fish essence.

Preferably, the water-retaining agent is sodium tripolyphosphate.

The present invention provides a preferred embodiment, in which the peanut protein vegetarian sausage is prepared from components including, in parts by weight, the following raw materials:

| | | |
|---|---|---|
| low-temperature defatted peanut protein powder | 55 to 75 | parts |
| soybean protein isolate | 5 to 20 | parts, |
| vital wheat gluten | 3 to 20 | parts, |
| essence | 0.5 to 1.5 | parts, |
| pigment | 0.005 to 0.05 | parts, |
| salt | 0.2 to 0.8 | parts, |
| water-retaining agent | 0.1 to 1 | parts, |

and, 0.05 to 1 parts of protease, or 0.05 to 1 parts of konjac flour, or 0.1 to 1 parts of sodium carbonate.

The taste of the vegetarian sausage of the present invention can be adjusted according to actual conditions. In the specific embodiment, in order to further reflect the comprehensive taste advantage of the prepared vegetarian sausage, vegetarian sausage with chicken taste is preferentially adopted in the present invention.

A chicken-flavored peanut protein vegetarian sausage, which is prepared from components including, in parts by weight, the following raw materials:

| | | |
|---|---|---|
| low-temperature defatted peanut protein powder | 60 to 85 | parts, |
| soybean protein isolate | 5 to 20 | parts, |
| vital wheat gluten | 8 to 15 | parts, |
| chicken essence | 0.5 to 1.5 | parts, |
| pigment | 0.005 to 0.01 | parts, |
| salt | 0.2 to 0.8 | parts, |
| water-retaining agent | 0.1 to 1 | parts, |

and

0.2 to 0.8 parts of glutamine transaminase, or 0.2 to 0.8 parts of konjac flour, or 0.2 to 0.8 parts of sodium carbonate.

The vegetarian sausage of the present invention reduces the beany flavor of the product which uses soybean protein as the main raw material, and improves the process of preparing a high moisture texturized peanut protein product by using the low-temperature defatted peanut protein powder as the main raw material. The vegetarian sausage has a protein content of up to 60%, zero cholesterol, and low fat, and has the characteristics of meaty taste, high elasticity, and being chewy and ready-to-eat.

A second purpose of the present invention is to provide a method for preparing the above-mentioned peanut protein vegetarian sausage, wherein the preparation method is a pure physical processing method with full use of the materials, high degree of automation, low energy consumption, and no pollutant discharge during processing. The preparation method opens up a new way for efficient utilization of vegetable proteins.

The preparation method specifically includes the following steps:

1) the low-temperature defatted peanut protein powder, the soybean protein isolate, and the vital wheat gluten are crushed, and then mixed well with the modifier, and allowed to stand to balance;

2) the balanced material in the step 1) is subjected to extrusion treatment at a temperature of 100 to 200° C., water and an auxiliary material are added online during the extrusion, and the product obtained after extrusion molding is cooled to give the peanut protein vegetarian sausage;

wherein, the amount of water added is such that the moisture content of the material during extrusion is 45% to 75%;

According to the present invention, the extrusion is performed at a temperature of 110 to 180° C.; preferably 150 to 170° C.

According to the present invention, the amount of water added is such that the moisture content of the material during extrusion is 52% to 68%, more preferably 60% to 66%.

According to the present invention, in order to make sure that the molecules in peanut protein powder, soybean protein isolate and vital wheat gluten are fully contacted, so as to facilitate the subsequent extrusion treatment to form a high-moisture peanut texturized protein, the mesh number of the crushed material is 60 to 80 mesh. Furthermore, the mixed material can be placed in a sealed container and balanced for a period of time. Generally, the time for balancing may be 20 to 30 h, for example 24 h.

According to the present invention, the screw rotation speed is 150 to 300 r/min and the feeding speed is 80 to 180 g/min during the extrusion;

Preferably, the screw rotation speed is 200 to 240 r/min, and the feeding speed is 90 to 150 g/min.

According to the present invention, the total amount of the auxiliary material is added to water at a mass ratio of 1:10-20 to prepare a compound solution, and the compound solution is added online at a flow rate of 1 to 5 kg/h;

Preferably, the total amount of the auxiliary material is added to water at a mass ratio of 1:15-15.5 to prepare a compound solution, and the compound solution is added online at a flow rate of 3 kg/h.

According to the present invention, the extrusion is carried out by using a twin-screw high-moisture extruder;

Preferably, the screw assembly mode adopts a high shear combination as follows: kneading blocks with a shear angle of 45° are selected as screw shear elements, and installed at intervals on a screw with a length-diameter ratio of 24:1, in five shear sections.

According to the present invention, the preparation method further comprises the steps of cutting and cooling the materials undergoing extrusion treatment and molding, for example, cutting the material from the extruder to a length of 10 to 20 cm to give a chicken-flavored peanut protein vegetarian sausage. The cut chicken-flavored peanut protein vegetarian sausage is placed in a vacuum packaging bag, vacuumized, sealed, sterilized, and cooled in a fluidized bed.

Preferably, a circular mold having a diameter of 15 to 30 mm is connected to the end of the extruder, and the cooling temperature is 45 to 80° C.; preferably, the cooling temperature is 60 to 70° C.

Preferably, the speed of a cutter at the exit of the circular mold is controlled to be 1 to 3 s/cut.

The present invention provides a preferred embodiment, the preparation method comprising the following steps:

1) the low-temperature defatted peanut protein powder, the soybean protein isolate, and the vital wheat gluten are crushed, sieved through a 60 to 80 mesh sieve, then mixed well with the modifier, and allowed to stand to balance;

2) the balanced material from the step 1) is subjected to extrusion treatment at a temperature of 150 to 170° C. by a twin-screw high-moisture extruder, and water and an auxiliary material are added online during the extrusion, the resultant is extruded into a circular shape having a diameter of 15 to 30 mm, and the product obtained is cooled at a temperature of 45 to 80° C. to give the peanut protein vegetarian sausage.

Wherein, the amount of water added is such that the moisture content of the material during extrusion is 60% to 66%.

The vegetarian sausage prepared in the present invention shows a color brightness value L>48, a transverse shear force of 0.35 to 0.6 kg, a longitudinal shear force of 0.28 to 0.5 kg, a texturizing degree of 1.0 to 1.4, a chewiness (×10³) of 2.5 to 6.0, an elasticity of 0.90 to 0.98, and a hardness of 5.8 to 10.0 kg.

Preferably, the vegetarian sausage has a moisture content of 50% to 65%.

The color brightness, transverse shear force, longitudinal shear force, texturizing degree, chewiness, elasticity, and hardness can be detected by methods generally used in the art.

The present invention has at least the following beneficial effects:

(1) The vegetarian sausage of the present invention has a content of peanut protein powder of 50% or more, and is combined with appropriate soybean protein isolate and vital wheat gluten. The interaction of the materials not only makes it rich in nutrients, but also greatly reduces the beany flavor of the product.

(2) The modifier added in the present invention effectively improves the quality of the vegetarian sausage, such as fibrous structure, elasticity, and chewing feel.

(3) The present invention realizes on-line coloring and seasoning, which can greatly decrease the product processing procedures and make the color and taste of the vegetarian sausage more uniform in practical application.

(4) The preparation method of the present invention not only improves the taste of the product, decreases the processing procedure, but also reduces possible denaturation of the protein during the processing, and effectively retains the nutrient components in the vegetable protein.

### BRIEF DESCRIPTION OF THE DRAWINGS

FIG. 1 is a process flow diagram of the method of the present invention;

FIG. 2 is a picture showing a torn vegetarian sausage prepared in Example 1.

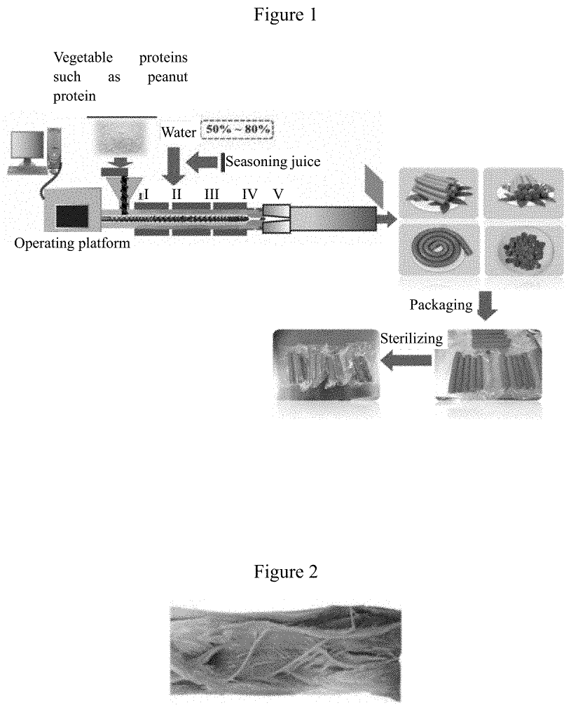

### SPECIFIC MODES FOR CARRYING OUT THE EMBODIMENTS

The following examples are intended to illustrate the invention but are not intended to limit the scope of the present invention. The operations involved in the Examples are routinely operated in the art unless otherwise specified. The conditions of implementation in the Examples can be further adjusted depending on the specific experimental conditions or factory conditions, and the conditions that do not indicate the conditions of implementation are usually the conditions in a routine experiment.

The following extrusion texturization treatment uses a domestic twin-screw high-moisture extruder.

The water-retaining agent used in the following Examples was sodium tripolyphosphate, which was purchased from Beijing Solaibao Technology Co., Ltd.

The following documents may be referred to for the methods of detecting color brightness, transverse shear force, longitudinal shear force, texturizing degree, chewiness, elasticity, hardness and like parameters:
1. L I Shujing. Study on relationship between thermal properties of raw materials and texture properties of extrusion-texturized proteins [D]. Chinese Academy of Agricultural Sciences, 2014.
2. Feng Xiaolong. Study on preparation, modification and application of peanut protein components [D]. Chinese Academy of Agricultural Sciences, 2014.
3. ZHANG Cuan. Study on peanut protein extrusion texturization technology and underlying mechanisms [D]. Northwest A & F University, 2007.

The following low-temperature defatted peanut protein powder, soybean protein isolate and vital wheat gluten are domestically produced, and the basic physical and chemical indicators are as follows:

| | Low-temperature | | |
|---|---|---|---|
| | defatted peanut | Soybean protein | Vital wheat |
| Item | protein powder | isolate | gluten |
| Crude protein | 60.75 ± 0.748 | 85.26 ± 1.978 | 67.95 ± 0.817 |
| content % | | | |
| (×5.46 dry basis) | | | |
| Crude fat | 6.95 ± 0.044 | 1.64 ± 0.110 | 0.88 ± 0.12 |
| content % | | | |
| (dry basis) | | | |
| Moisture % | 5.82 ± 0.057 | 5.61 ± 0.034 | 10.84 ± 0.084 |

### Example 1

The present Example provides a peanut protein vegetarian sausage, which was prepared from components including, in parts by weight, the following raw materials:

| | | |
|---|---|---|
| low-temperature defatted peanut protein powder | 75 | parts |
| soybean protein isolate | 10 | parts |
| vital wheat gluten | 8 | parts |
| chicken essence | 1 | parts |
| pigment | 0.05 | parts |
| salt | 0.3 | parts |
| water-retaining agent | 0.2 | parts |
| glutamine transaminase | 0.5 | parts. |

### Example 2

The present Example provides a peanut protein vegetarian sausage, which was prepared from components including, in parts by weight, the following raw materials:

| | | |
|---|---|---|
| low-temperature defatted peanut protein powder | 85 | parts |
| soybean protein isolate | 5 | parts |
| vital wheat gluten | 3 | parts |
| chicken essence | 1 | parts |
| pigment | 0.05 | parts |
| salt | 0.3 | parts |
| water-retaining agent | 0.2 | parts |
| glutamine transaminase | 0.5 | parts. |

### Example 3

The present Example provides a peanut protein vegetarian sausage, which was prepared from components including, in parts by weight, the following raw materials:

| | | |
|---|---|---|
| low-temperature defatted peanut protein powder | 55 | parts |
| soybean protein isolate | 20 | parts |
| vital wheat gluten | 20 | parts |
| chicken essence | 1 | parts |
| pigment | 0.05 | parts |
| salt | 0.3 | parts |
| water-retaining agent | 0.2 | parts |
| glutamine transaminase | 0.5 | parts. |

### Example 4

The present Example provides a peanut protein vegetarian sausage, which was the same as Example 1 except that 0.5 parts of glutamine transaminase was replaced with 0.5 parts of konjac flour.

### Example 5

The present Example provides a peanut protein vegetarian sausage, which was the same as Example 1 except that 0.5 parts of glutamine transaminase was replaced with 0.8 parts of sodium carbonate.

### Example 6

The present Example provides a method for preparing the vegetarian sausage according to Example 1, the method comprises the following steps:

1) the peanut protein powder, the soybean protein isolate, and the vital wheat gluten were crushed, sieved through a 60 to 80 mesh sieve, then mixed well with the modifier, and allowed to stand for 20 to 24 hours to balance;

2) the balanced material from the step 1) was subjected to extrusion treatment at a temperature of 160° C. by a twin-screw high-moisture extruder with a screw rotation speed of 240 r/min and a feeding speed of 130 g/min; water and an auxiliary material were added online during the extrusion; and the resultant was molded through a circular cooled mold with a diameter of 15 to 30 mm, wherein cooling temperature for the mold was set at 65° C.;

Wherein, the amount of water added was such that the moisture content of the material during the extrusion was 64%; the auxiliary material was added to water at a mass ratio of 1:15-15.5 to prepare a compound solution, and the compound solution was added online at a flow rate of 3 kg/h;

3) at the exit of the extruder, the cooled vegetarian sausage was cut into strips with a length of about 10 cm by a hydraulic cutter, and then vacuum packaged, and sterilized at 121° C. for 20 min.

The vegetarian sausage prepared in the present Example was tested and the results were as follows:

TABLE 1

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 50.58 | 1.20 | 0.526 | 0.439 | 2.56 | 5.81 | 0.93 |

### Example 7

The present Example provides a method for preparing the vegetarian sausage according to Example 2, the operations of which were the same as those in Example 6.

The vegetarian sausage prepared in the present Example was tested and the results were as follows:

TABLE 2

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 55.63 | 1.01 | 0.351 | 0.301 | 2.50 | 5.80 | 0.90 |

### Example 8

The present Example provides a method for preparing the vegetarian sausage according to Example 3, the operations of which were the same as those in Example 6.

The vegetarian sausage prepared in the present Example was tested and the results were as follows:

TABLE 3

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 48.05 | 1.36 | 0.593 | 0.493 | 6.00 | 9.89 | 0.97 |

### Example 9

The present Example provides a method for preparing the vegetarian sausage according to Example 4, and the difference of the method as compared with Example 6 lied in the extrusion temperature of 125° C. in addition to the modifier.

The vegetarian sausage prepared in the present Example was tested and the results were as follows:

TABLE 4

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 51.40 | 1.15 | 0.557 | 0.489 | 5.24 | 9.58 | 0.90 |

### Example 10

The present Example provides a method for preparing the vegetarian sausage according to Example 5, the operations of which were the same as those of Example 6 except for the modifier.

The vegetarian sausage prepared in the present Example was tested and the results were as follows:

TABLE 5

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 48.35 | 1.15 | 0.374 | 0.285 | 3.76 | 6.21 | 0.94 |

### Example 11

The present Example provides a method for preparing a vegetarian sausage, which used the same raw materials as Example 1, and was the same as Example 6 except that the cooling temperature of the mold was 45° C.

The vegetarian sausage prepared in the present Example was tested and the results were as follows:

TABLE 4

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 49.74 | 1.27 | 0.650 | 0.512 | 2.93 | 6.06 | 0.95 |

### Comparative Example 1

The present Comparative Example provides a peanut protein vegetarian sausage, which was the same as that of Example 1 except that no modifier was added. The vegetarian sausage was prepared by the preparation method of Example 6.

The vegetarian sausage prepared in the present Comparative Example was tested and the results were as follows:

TABLE 6

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 50.58 | 0.97 | 0.514 | 0.532 | 4.14 | 8.65 | 0.89 |

### Comparative Example 2

The present Comparative Example provides a peanut protein vegetarian sausage, which was the same as that of Example 1 except that the amount of the glutamine transaminase added was 3 parts. The vegetarian sausage was prepared by the preparation method of Example 6.

The vegetarian sausage prepared in the present Comparative Example was tested and the results were as follows:

TABLE 7

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 50.41 | 1.05 | 0.59 | 0.56 | 8.90 | 12.45 | 0.88 |

### Comparative Example 3

The present Comparative Example provides a method for preparing a peanut protein vegetarian sausage, which was the same as that of Example 6 except that the amount of water added in step 2) was such that the moisture content of the material during extrusion was 50%.

The vegetarian sausage prepared in the present Comparative Example was tested and the results were as follows:

TABLE 8

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 51.77 | 0.96 | 0.476 | 0.498 | 8.18 | 13.68 | 0.92 |

### Comparative Example 4

The present Comparative Example provides a method for preparing a peanut protein vegetarian sausage, which was the same as that of Example 8 except that the amount of sodium carbonate added was 4 parts.

The vegetarian sausage prepared in the present Comparative Example was tested and the results were as follows:

TABLE 9

| Color | Textur- | Transverse | Longitudinal | | Hard- | |
|---|---|---|---|---|---|---|
| bright- | izing | shear force | shear force | Chewiness | ness | Elas- |
| ness L | degree | (kg) | (kg) | (×10³) | (kg) | ticity |
| 47.18 | 1.31 | 0.374 | 0.285 | 1.94 | 4.54 | 0.90 |

### Comparative Example 5

The present Comparative Example provides a peanut protein vegetarian sausage, which was the same as that of Example 1 except that the low-temperature defatted peanut powder is replaced with a high-temperature defatted peanut powder. The vegetarian sausage was not successfully produced by using the same method as Example 6.

### Experimental Example 1

The vegetarian sausages prepared in Examples 6-11 and Comparative Examples 1-5 were compared for properties and mouthfeel, and the results were as follows:

TABLE 10
Comparison results

| | index | | | | | | |
|---|---|---|---|---|---|---|---|
| | Color | Appearance | Texturizing | | | | |
| No. | brightness | State | degree | Hardness | Elasticity | Chewiness | Taste |
| Example 6 | Bright | Relatively | Strong | Moderate | Strong | Relatively | Relatively |
| | | Regular | | | | Low | Good |
| Example 7 | Bright | Regular | Relatively | Relatively | Relatively | Relatively | Good |
| | | | strong | Soft | strong | Low | |
| Example 8 | Relatively | Deformed | Strong | Hard | Strong | High | Relatively |
| | Dark | | | | | | Bad |
| Example 9 | Bright | Relatively | Relatively | Relatively | Relatively | Relatively | Good |
| | | Regular | strong | Hard | strong | High | |
| Example 10 | Relatively | Deformed | Relatively | Moderate | Strong | Relatively | Relatively |
| | Dark | | strong | | | High | Good |
| Example 11 | Relatively | Deformed | Strong | Moderate | Strong | Relatively | Good |
| | Bright | | | | | Low | |
| Comparative | Bright | Deformed | Relatively | Relatively | Weak | Relatively | Relatively |
| Example 1 | | | Weak | Hard | | High | Good |
| Comparative | Bright | Deformed | Relatively | Hard | Weak | Relatively | Relatively |
| Example 2 | | | strong | | | High | Good |
| Comparative | Bright | Cracked | Relatively | High | Strong | High | Relatively |
| Example 3 | | | Weak | | | | Bad |
| Comparative | Dark | Relatively | Strong | Low | Relatively | Low | Bad |
| Example 4 | | Regular | | | strong | | |
| Comparative | Dark | Irregular | / | / | / | / | / |
| Example 5 | | | | | | | |

Although the present invention has been described in detail above with the aid of the general description, the specific embodiments and the Examples, however, it will be apparent to a person skilled in the art that modifications or improvements can be made thereto based on the present invention. Therefore, such modifications or improvements made without departing from the spirit of the present invention are intended to be within the scope of the present invention.

### INDUSTRIAL APPLICABILITY

The present invention provides a peanut protein vegetarian sausage and a preparation method thereof. The peanut protein vegetarian sausage of the present invention is prepared from components including, in parts by weight, the following raw materials: 50 to 100 parts of low-temperature defatted peanut protein powder, 5 to 50 parts of soybean protein isolate, 5 to 50 parts of vital wheat gluten, and 0.1 to 10 parts of modifier. The vegetarian sausage provided by the present invention has a protein content of 60% or more, zero cholesterol and low fat, and has the characteristics of good taste, being rich in nutrients and convenience to eat. Further, the preparation method provided by the present invention is a pure physical processing method with a high degree of automation, and the processing is free from any pollutant discharge. The peanut protein vegetarian sausage of the present invention has high economic value and good application prospect.

1. A peanut protein vegetarian sausage, wherein the vegetarian sausage is prepared from components including, in parts by weight, the following raw materials:

| low-temperature defatted peanut protein powder | 50 to 100 | parts |
|---|---|---|
| soybean protein isolate | 5 to 50 | parts, |
| vital wheat gluten | 5 to 50 parts, and | |
| modifier | 0.01 to 3 | parts. |

2. The vegetarian sausage according to claim 1, wherein the low-temperature defatted peanut protein powder has a protein content of 55% or more, and a fat content of 7% or less;
and/or, the soybean protein isolate has a protein content of 80% or more, and a fat content of 1.8% or less;
and/or, the vital wheat gluten has a protein content of 60% or more, and a fat content of 0.9% or less.

3. The vegetarian sausage according to claim 1, wherein the modifier is one or more selected from protease, konjac flour, and sodium carbonate.

4. The vegetarian sausage according to claim 1, further comprising an auxiliary material, the auxiliary material is one or more of essence, pigment, salt, and water-retaining agent.

5. The vegetarian sausage according to claim 1, wherein the vegetarian sausage is prepared from components including, in parts by weight, the following raw materials:

| | | |
|---|---|---|
| low-temperature defatted peanut protein powder | 55 to 75 | parts |
| soybean protein isolate | 5 to 20 | parts, |
| vital wheat gluten | 3 to 20 | parts, |
| essence | 0.5 to 1.5 | parts, |
| pigment | 0.01 to 0.1 | parts, |
| salt | 0.2 to 0.8 | parts, |
| water-retaining agent | 0.1 to 1 | parts, |

and, 0.05 to 1 parts of protease, or 0.05 to 1 parts of konjac flour, or 0.1 to 1 parts of sodium carbonate.

6. A method for preparing the vegetarian sausage according to claim 1, comprising the following steps:
1) the low-temperature defatted peanut protein powder, the soybean protein isolate, and the vital wheat gluten are crushed, then mixed well with the modifier, and allowed to stand to balance;
2) the balanced material from the step 1) is subjected to extrusion treatment at a temperature of 100 to 200° C., and water and an auxiliary material are added online during the extrusion, and the product obtained after extrusion molding is cooled to give the peanut protein vegetarian sausage;
wherein, the amount of water added is such that the moisture content of the material during extrusion is 45% to 75%.

7. The preparation method according to claim 6, wherein the screw rotation speed is 150 to 300 r/min and the feeding speed is 80 to 180 g/min during the extrusion.

8. The preparation method according to claim 6, wherein the total amount of the auxiliary material is added to water at a mass ratio of 1:10-20 to prepare a compound solution, and the compound solution is added online at a flow rate of 1 to 5 kg/h.

9. The preparation method according to claim 6, wherein the extrusion is carried out by using a twin-screw high-moisture extruder.

10. The preparation method according to claim 9, wherein, a circular mold having a diameter of 15 to 30 mm is connected to the end of the extruder, and the cooling temperature is 45 to 80° C.
